(19) United States
(12) Patent Application Publication
(10) Pub. No.: US 2010/0277576 A1
(43) Pub. Date: Nov. 4, 2010

(54) Systems for Capturing Images Through a Display

(76) Inventors: David Fattal, Mountain View, CA (US); Ramin Samadani, Palo Alto, CA (US); Ian N. Robinson, Pebble Beach, CA (US); Kar Han Tan, Sunnyvale, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/770,589

(22) Filed: Apr. 29, 2010

Related U.S. Application Data
(63) Continuation-in-part of application No. 12/432,550, filed on Apr. 29, 2009.

(51) Int. Cl. H04N 5/225; H04N 13/04

(52) U.S. Cl. 348/54; 348/342; 348/E13.075; 348/E05.024

(57) ABSTRACT

The present invention describes a visual-collaborative system comprising: a display screen having a first surface and a second surface; a first projector positioned to project images onto a projection surface of the display screen, wherein the projected images can be observed by viewing the second surface; and a first camera system positioned to capture images of objects through the display screen, the first camera system including a first filter disposed between a first camera and the first surface, wherein the first filter passes the light received by the camera but substantially blocks the light produced by the first projector, wherein the first filter is a GMR (Guided Mode Resonance) filter.

### CROSS-REFERENCE TO RELATED APPLICATION

This case is a continuation-in-part of the case entitled “Systems for Capturing Images Through a Display” filed on Apr. 29, 2009, having U.S. Ser. No. 12/432,550, which is hereby incorporated by reference in it's entirety.

### TECHNICAL FIELD

Embodiments of the current invention relate to remote collaboration systems.

### BACKGROUND

Some of the most productive interactions in the workplace occur when a small group of people get together at a blackboard or a whiteboard and actively participate in presenting and discussing ideas. However it is very hard to support this style of interaction when one or more participants are at a different location, a situation that occurs more and more frequently as organizations become more geographically distributed. To date, conventional video-conferencing systems are not well suited to this scenario. Effective collaboration relies on the ability for the parties to see each other and the shared collaboration surface, and to see where the others are looking and/or gesturing. Conventional video-conferencing systems can use multi-user screen-sharing applications to provide a shared workspace, but there is a disconnect from the images of the remote participants and the cursors moving over the shared application.

FIGS. 1-3 show schematic representations of systems configured to project images without interfering with images captured by a camera. FIG. 1 shows a communication medium with a half-silvered mirror 102, a camera 104 located above the mirror 102, and a projector 106. The mirror 102 and the projector 106 are positioned so that an image of a person or object located at a remote site is projected by the projector 106 onto the rear surface of the half-silvered mirror 102 and is visible to a viewer 108. The camera 104 captures an image of the viewer 108 via that viewer's reflection in the mirror 102 and transmits the image to another person. The configuration of mirror 102, projector 106, and camera 104 enable the viewer 108 to have a virtual face-to-face interaction with the other person. However, close interaction between the viewer 108 and the other person can be disconcerting because the tilted screen makes for unnatural views of the remote user. FIG. 2 shows a communication medium with a switchable diffusing screen 202, a camera 204, and a projector 206. The screen 202 can be composed of a material that can be cycled rapidly between diffusive and transparent states. The state of the screen 202, projector 206, and camera 204 can be synchronized so that the projector 206 projects images when the screen is diffusive and the camera 204 captures images when the screen in transparent. However, it is difficult to design a screen that can switch fast enough to avoid flicker, and the need to synchronize these fast switching components adds to the complexity of the system and limits the projected and captured light levels. FIG. 3 shows a top view of a communication medium with two cameras 302 and 304 on each side of a display 306. Images of a viewer 308, for example, are captured by the cameras 302 and 304 and processed to create a single image of the viewer 308 which appears to be captured by a single virtual camera 310 for viewing by another person at a different location. However, an image captured in this manner typically suffers from processing artifacts, especially when the captured views are at a very different angle from the intended virtual view, as would be the case with a user close to a large screen. This system also fails to capture hand gestures near, or drawing on, the screen surface.

It is desirable to have visual-collaborative systems that project images without interfering with and diminishing the quality of the images simultaneously captured by a camera.

### BRIEF DESCRIPTION OF DRAWINGS

The figures depict implementations/embodiments of the invention and not the invention itself. Some embodiments are described, by way of example, with respect to the following Figures.

FIGS. 1-3 show schematic representations of systems configured to project images without interfering with images captured by a camera.

FIG. 4 shows a schematic representation of a first visual-collaborative system configured in accordance with embodiments of the present invention.

FIG. 5 shows a plot of exemplary wavelength ranges over which two filters transmit light in accordance with embodiments of the present invention.

FIG. 6A illustrates a cross-sectional view of a 1D Guided Mode Resonance grating according to an embodiment of the invention.

FIG. 6B illustrates a cross-sectional view of a 1D Guide Mode Resonance grating according to another embodiment of the present invention.

FIG. 7 shows a schematic representation of a second visual-collaborative system configured in accordance with embodiments of the present invention.

FIG. 8A shows a schematic representation of a third visual-collaborative system configured in accordance with embodiments of the present invention.

FIG. 8B shows two color wheels configured in accordance with embodiments of the present invention.

FIG. 8C shows plots of exemplary wavelength ranges over which two filters transmit light in accordance with embodiments of the present invention.

FIG. 9 shows a schematic representation of a sixth visual-collaborative system configured in accordance with embodiments of the present invention.

FIG. 10 shows a camera positioned at approximately eye level to a viewer in accordance with embodiments of the present invention.

FIG. 11 shows a schematic representation of a seventh visual-collaborative system configured in accordance with embodiments of the present invention.

FIG. 12 shows a schematic representation of an eight visual-collaborative system configured in accordance with embodiments of the present invention.

FIG. 13 shows a schematic representation of a ninth visual-collaborative system configured in accordance with embodiments of the present invention.

FIGS. 14A-14B show a schematic representation of a tenth visual-collaborative system configured in accordance with embodiments of the present invention.

FIG. 15A illustrates a perspective view of a 2D GMR grating according to an embodiment of the present invention.

FIG. 15B illustrates a perspective view of a 2D GMR grating according to another embodiment of the present invention.

FIG. 16 shows a schematic representation of an eleventh visual-collaborative system configured in accordance with embodiments of the present invention.

FIGS. 17A-17B show isometric views of interactive video conferencing using visual-collaborative systems in accordance with embodiments of the present invention.

FIG. 18 shows a flow diagram for a method for video collaborative interaction in accordance with embodiments of the present invention.

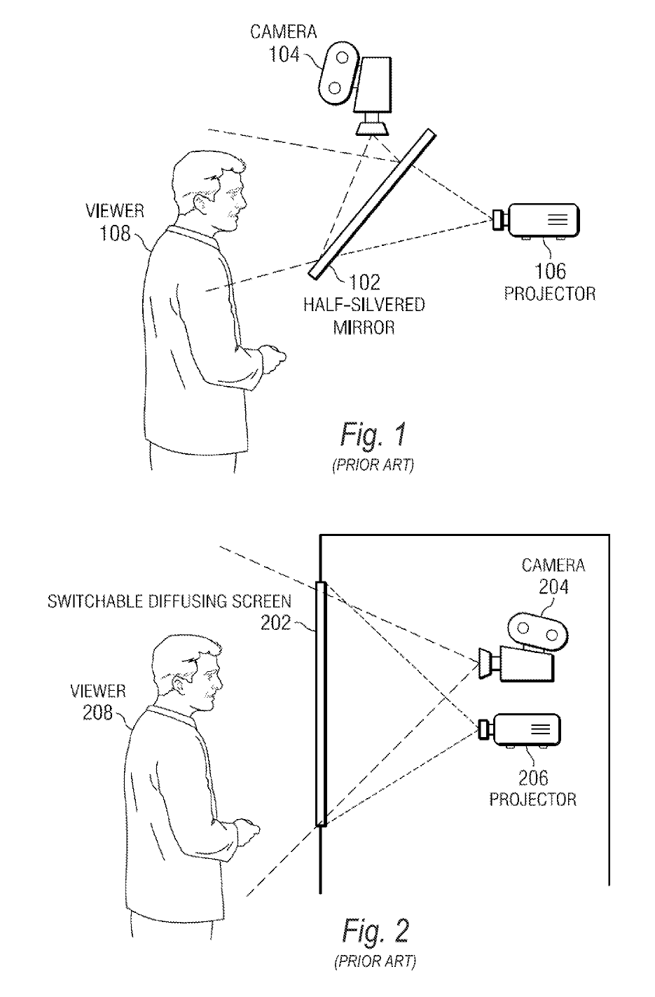

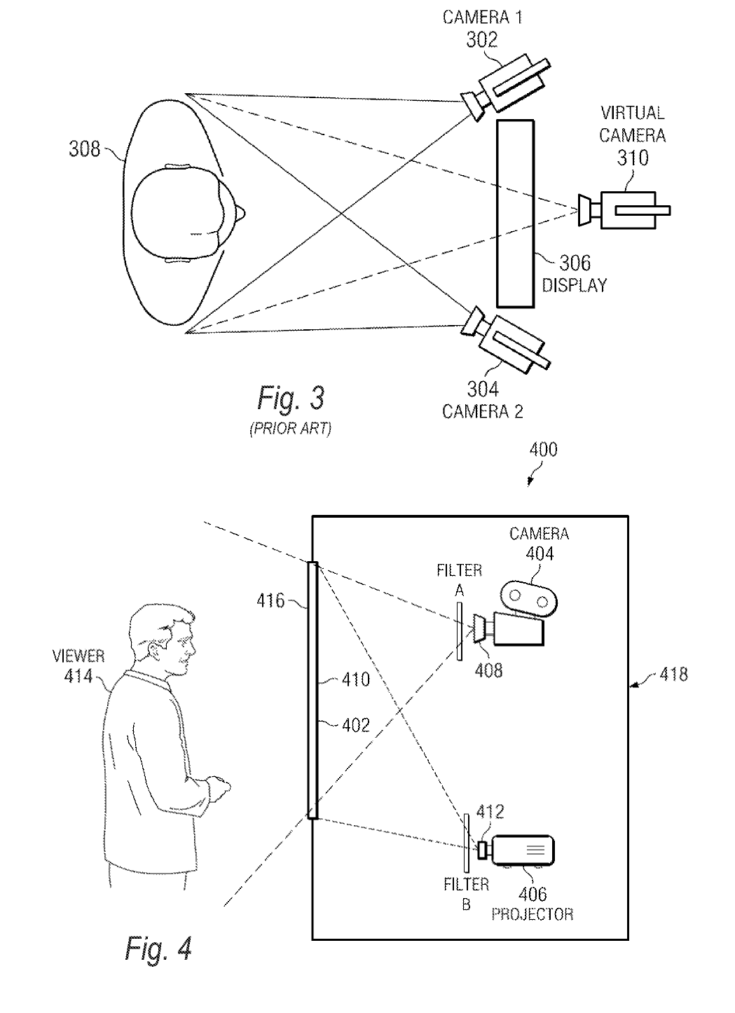

The drawings referred to in this Brief Description should not be understood as being drawn to scale unless specifically noted.

### DETAILED DESCRIPTION OF EMBODIMENTS

Embodiments of the present invention are directed to visual-collaborative systems enabling geographically distributed groups to engage in face-to-face, interactive collaborative video conferences. The systems include a projection display screen that enables cameras to capture images of the local objects through the display screen and send the images to a remote site. In addition, the display screen can be used to simultaneously display images from the remote site.

FIG. 4 shows a schematic representation of a visual-collaborative system 400 configured in accordance with embodiments of the present invention. The system 400 comprises a display screen 402, a camera 404, and a projector 406 and includes a filter A disposed between the camera lens 408 and the screen 402 and a filter B disposed between the projector lens 412 and the screen 402. The camera lens 408 and projector lens 412 are positioned to face the same first surface 410 of the display screen 402. In the embodiments described in FIGS. 4-9, the screen 402 is a rear projection display screen. However, the rear projection implementation shown is for purposes of example only and the screen 402 may also be a front projection display screen. A front projection implementation is shown in FIGS. 10-13.

Referring to FIG. 4, the screen 402 is a rear projection display screen comprising a screen material that diffuses light striking the first surface 410 within a first range of angles. The projector 406 is positioned to project images onto the first surface 410 within the first range of angles. A viewer 414 facing the outer second surface 416 of the screen 402 sees the images projected onto the screen 402 from the projector 406. The screen 402 is also configured to transmit light scattered from objects facing the second surface 416. In other words, the camera lens 408 is positioned to face the first surface 410 so that light scattered off of objects facing the second surface 416 pass through the display screen and is captured as images of the objects by the camera 404.

In certain embodiments, the display screen 402 comprises a relatively low concentration of diffusing particles embedded within a transparent screen medium. The low concentration of diffusing particles allows a camera 404 to capture an image through the screen (providing the subject is well lit), while diffusing enough of the light from the projector 406 to form an image on the screen. In other embodiments, the display screen 402 can be a holographic film that has been configured to accept light from the projector 406 within a first range of angles and transmit light that is visible to the viewer 414 within a different range of viewing angles. The holographic film is otherwise transparent. In both embodiments, light projected onto the first surface 410 within the first range of angles can be observed by viewing the second surface 416, but light striking the second surface 416 is transmitted through the screen 402 to the camera. However, in both embodiments the camera 404 also captures light from the projector 406 diffused or scattered off the first surface 410.

In order to prevent ambient light from striking the first surface 410 of the screen 402 and reducing the contrast of the projected and captured images, the system 400 may also include a housing 418 enclosing the camera 404 and projector 406. The housing 418 is configured with an opening enclosing the boundaries of the screen 402 and is configured so that light can only enter and exit the housing 418 through the screen 402.

As shown in FIG. 4, filters A and B are positioned so that light output from the projector 406 passes through filter B before striking the first surface 410 and light captured by the camera 404 passes through filter A. The filters A and B are configured to prevent light produced by the projector 406 and scattered or diffused from the screen 402 from interfering with light transmitted through the screen 402 and captured by the camera 404. In one embodiment, this is achieved using complementary filters to block different components of light. In one embodiment, filter A passes through light that would be blocked by filter B. Similarly, filter B passes light that would be blocked by filter A. In this way, light from the projector 406 that is diffused or scattered off the first surface may be blocked.

This implementation (filter A passing light blocked by filter B and filter B passing light blocked by filter A) is implemented in FIG. 4 where the camera system includes a first filter (filter A) that is disposed between the camera and the first surface of the display screen. Filter A passes the light received by the camera, except for the light produced by the projector (which it blocks). A second filter (filter B) disposed between the light source of the projector and the projection surface of the display screen, wherein the second filter passes light output by the projector that is blocked by the first filter.

If the material used for the display screen 402 maintains polarization of scattered light, and if the projectors used are the type which result in no polarization of the light output from the projectors, then polarized filters may be used. In one embodiment, the complementary filters A and B are polarizing filters, where polarizing filter A has a first direction of orientation that is different than the direction of orientation of polarizing filter B. In one embodiment, the filters are circularly polarized, where the polarization for one filter is right circularly polarized and the polarization for the other filter is left circularly polarized. In one embodiment, the two filters are polarized linearly. In this embodiment, one filter is polarized horizontally while the other filter is polarized vertically.

Although the term blocked is used throughout the application, it is realized that in some cases a filter might not block 100% of the light of the complementary filter so that the filters are completely non-overlapping. However, when the filters are non-overlapping, the best performance is typically achieved. For example, in the embodiment where the filters are linearly polarized with one filter (assume for purposes of example filter A) is polarized horizontally and the other filter (filter B) is polarized vertically, preferably, the direction of orientation of the filters is orthogonal to each other. In this implementation, the filters are non-overlapping and filter A blocks light that would not be blocked by filter B and filter B blocks light that would not be blocked by filter A. Although orientations other than a 90 degree orthogonal positioning may be used, this is not desirable since as the orientation of the two filters moves further away from it's orthogonal positioning, relative to each other, the further the system performance is decreased.

For purposes of example, assume that filter A is positioned at an 88 degree angle relative to filter B (as opposed to the preferred 90 degree positioning.) Although the filters are not completely non-overlapping, typically the filter arrangement would still provide a configuration that would substantially block light from the complementary filter such that performance is not noticeably degraded to the viewer (as compared to the 90 degree orthogonal positioning). The degree to which the images are visually degraded is to some extent a function of the media content and the environment (brightness, etc) of the viewers. For example, if the media content includes a black and white checkerboard image (high brightness for white image and high contrast), an 88 degree relative positioning may not be sufficiently non-overlapping to provide an image that is not noticeably degraded. In contrast, if the media content is relatively dark compared to the checkerboard content or the viewer is an a low light environment for example, an 88 degree relative positioning of the filter may provide little if any noticeable degradation by the viewer. Thus for this case, the 88 degree relative position which substantially blocks (but not completely blocks) the light produced by the projector results in minimum degradation of performance. Thus “block” and “substantially blocked” may be used interchangeable as long as difference in blocking results in visual degradation that is either minimal or not apparent to the viewer. Light that is “substantially blocked” by a filter may correspondingly be “substantially transmitted” by it's complementary filter.

As previously noted, it is desirable for the filters A and B to be configured to prevent light produced by the projector and scattered or diffused from the screen 402 from interfering with light transmitted through the screen 402 and captured by the camera 404. In the embodiment previously described, this is accomplished using a first type of filter, a polarized filter. However, other types of filters may be used. In an alternative embodiment, this can be achieved using a second type of filter, a wavelength division filters.

In particular, filter B can be configured to transmit a first set of wavelengths ranges that when combined create the visual sensation of a much broader range of colors in projecting images on the display screen 402, and filter A can be configured to transmit a second set of wavelength ranges that are different from the first set of wavelength ranges. The second set of wavelength ranges can also be used to create the visual sensation of a much broader range of colors. In other words, filter A is configured and positioned to block the wavelength ranges that are used to create images on the display screen 402 from entering the camera lens 408. Even though the wavelength ranges used to produce images viewed by the viewer 414 are different from the wavelengths of light used to capture images by the camera 404, the projector 406 can still use the colors transmitted through filter B to project full color images and light transmitted through filter A and captured by the camera 404 can still be used to record and send full color images. It is the component wavelengths of the light used to project and capture the full color images that are prevented from interfering. Similar to the descriptions with respect to polarized filters, wavelength division filters may not completely be non-overlapping so that a filter may substantially block a set of wavelength ranges.

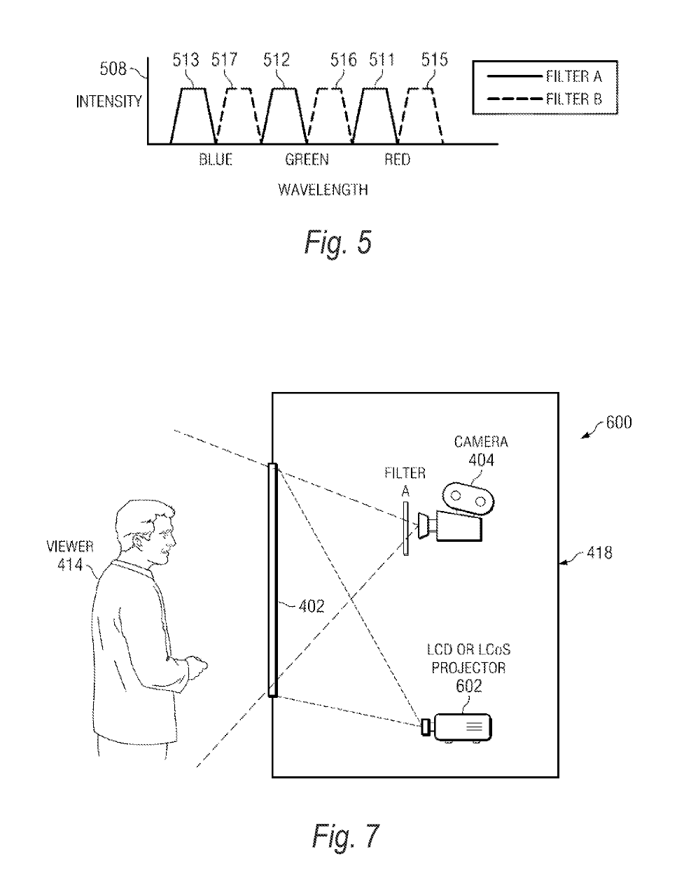

FIG. 5 shows exemplary plots 502 and 504 of wavelength ranges over which filters A and B, respectively, can be configured to transmit light in accordance with embodiments of the present invention. Horizontal line 506 represents the range of wavelengths comprising the visual spectrum. Vertical axes 508 and 510 represents intensities of light transmitted through filters A and B, respectively. As shown in FIG. 5, the red, green and blue portions of the spectrum are each split into two halves with curves 511-513 representing relatively shorter wavelength rangers of the red, green, and blue portions of visible spectrum transmitted through filter A and curves 515-517 representing relatively longer wavelength ranges of the red, green, and blue portions of visible spectrum transmitted through filter B. As shown in FIG. 5, filters A and B do not transmit the same wavelength ranges of the red, green, and blue portions of the visible spectrum. In particular, filter A is configured to transmit shorter wavelength ranges of the red, green, and blue portions of the visible spectrum, and substantially block the longer wavelength ranges of the red, green, and blue portions of the spectrum. In contrast, filter B is configured to transmit the longer wavelengths ranges of the red, green, and blue portions of the visible spectrum and substantially block the short wavelength ranges of the red, green, and blue portions of the visible spectrum. Both sets of red, green, and blue wavelengths can be treated as primary colors that can be combined to produce a full range of colors in projecting images on the display screen 402 and capturing images through the display screen 402. Thus, the combination of filters A and B effectively block the light used to project color images on the display screen 402 form being back scattered and interfering with the color images captured by the camera 404.

In other embodiments, operation of the filters A and B can be reversed. In other words, filter A can transmit the longer wavelength ranges of the red, green, and blue portions of the visual spectrum while filter B transmits the shorter wavelength ranges of the red, green, and blue portions of the visible spectrum.

Dielectric multi-layer filters can be used to implement the wavelength division filters A and B in the described visual collaborative system. Alternatively, a Guided Mode Resonance (GMR) device could be used to implement either the polarized filter or wavelength division filters described herein. For example, in one embodiment polarized filters A and B are implemented using GMR filters. In another embodiment, GMR filters are used to implement wavelength division filters A and B.

As background, a GMR filter is a combination of a planar dielectric waveguide and a grating that has a first order diffraction that occurs at a specific wavelength into a trapped waveguide mode. As used herein, ‘guided-mode resonance’ is defined as an anomalous resonance excited in, and simultaneously extracted from, a waveguide by a phase-matching element such as a diffraction grating. An excitation signal or wave (e.g., light) incident on the diffraction grating is coupled into and is essentially, but generally temporarily, ‘trapped’ as energy in a resonance mode in the waveguide under some circumstances, such as certain combinations of angle of incidence and signal wavelength. The resonance mode may manifest as an excitation of surface waves (i.e., surface plasmon) on a surface of a metallic grating or as a resonant wave (e.g., guided-mode or quasi guided-mode) within a body of a dielectric layer of the waveguide, for example. The trapped energy may subsequently escape from the waveguide and combine one or both of constructively and destructively with either a signal reflected by the grating or a signal transmitted through the grating. Guided-mode resonances are also often referred to as ‘leaky resonances’.

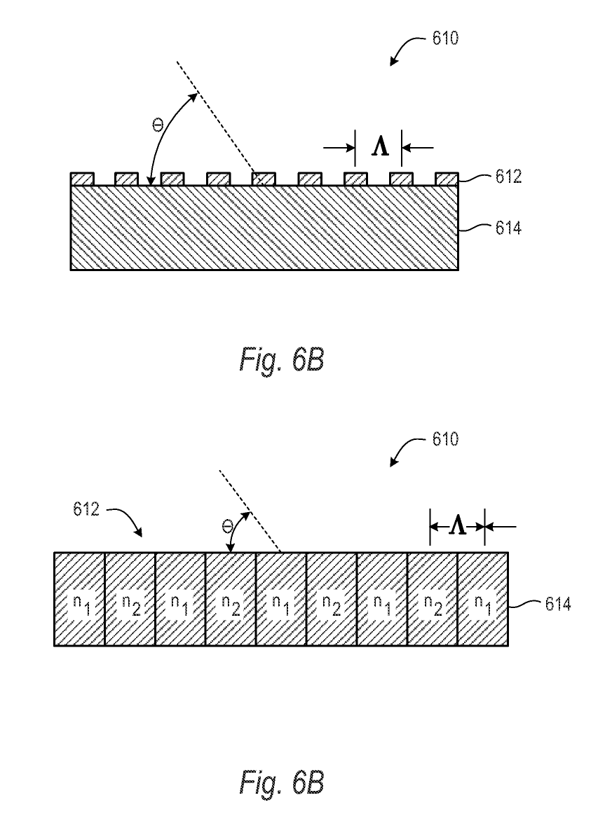

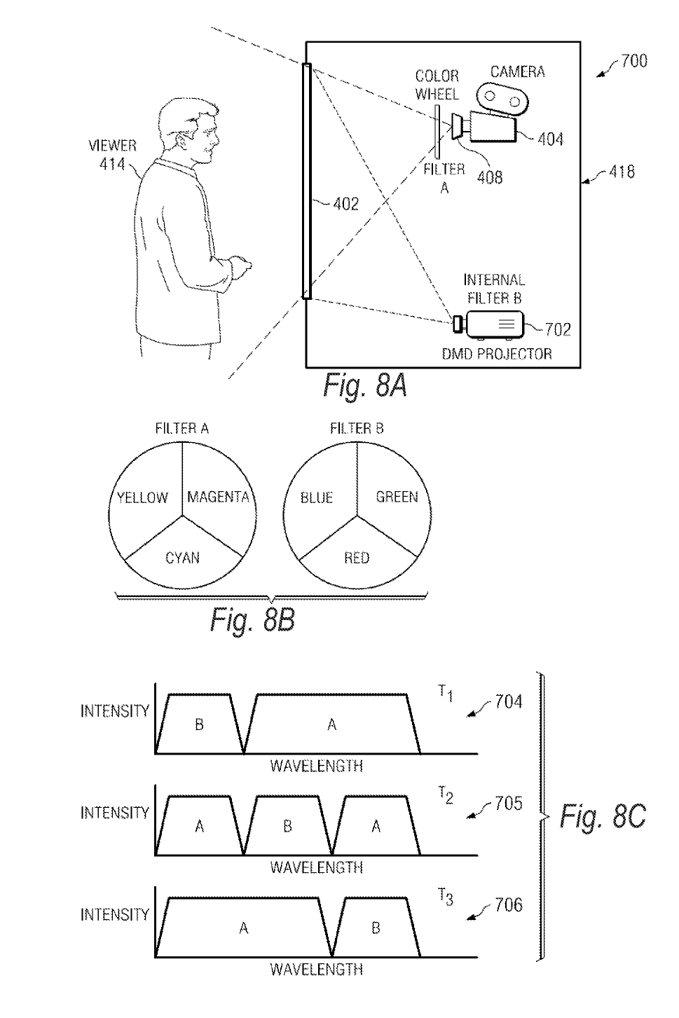

A ‘guided-mode resonance (GMR) grating’ as used herein is defined as any diffraction grating coupled with a waveguide that can support a guided-mode resonance. GMR gratings are also known and referred to as ‘resonant grating waveguides’ and ‘dielectric waveguide gratings’. FIG. 6A illustrates a cross-sectional view of a 1D GMR grating 610 according to an embodiment of the invention. The simplest type of GMR filter (as shown in FIG. 6A) has only a single layer (referred to as the “grating”) with the hole pattern etched directly into it. The critical feature for a GMR filter is that the refractive index of that layer must be greater than the refractive index of it's surroundings.

As shown in FIG. 6A, an optical GMR grating may comprise a dielectric slab waveguide with a diffraction grating formed in or on a surface layer thereof. The diffraction grating may comprise grooves or ridges formed on a surface of the dielectric slab. In another example (shown in FIG. 6B), the GMR grating is a planar dielectric sheet having a periodically alternating refractive index (e.g., phase grating) within the dielectric sheet. An exemplary phase grating may be formed by forming a periodic array of holes in and through the dielectric sheet. A signal incident on the surface of a GMR grating that excites a guided-mode resonance therein may be simultaneously extracted as one or both of a reflected signal (i.e., reflected waves) that reflects from an incident surface of the GMR grating or a transmitted signal (i.e., transmitted waves) that passes through the GMR grating and out a side of the GMR grating that is opposite the incident surface.

In various embodiments, the GMR grating may be either a 1-dimensional (1D) grating or a 2-dimensional grating. A 1D GMR grating may comprise a set of parallel and essentially straight grooves that are periodic only in a first direction (e.g., along an x-axis), for example. An example of a 2D GMR grating comprises an array of holes in a dielectric slab or sheet where the holes are periodically spaced along two orthogonal directions (e.g., along both an x-axis and a y-axis). A further discussion of GMR gratings and guided-mode resonance may be found, for example, in PCT/US2008/055833 “Angle Sensor System and Method Employing Guided Mode Resonance,” filed Apr. 9, 2008 which is incorporated by reference in it's entirety herein.

In some embodiments, the GMR grating 610 comprises a 1D diffraction grating of grating period Λ. Such embodiments are termed a ‘1D GMR grating’ herein. FIG. 6A illustrates a cross sectional view of a 1D GMR grating 610 according to an embodiment of the present invention. As illustrated, the 1D GMR grating 110 comprises a diffraction grating 612 formed on a top surface layer of a dielectric slab or layer 614. The diffraction grating 612 may be formed as periodically spaced apart grating elements that may be one or both of ridges and grooves with the grating period Λ, for example. The grating elements may be formed mechanically by molding or etching, for example. Alternatively, the grating elements may be formed by depositing and patterning another material (e.g., a dielectric or a metal) on a surface of the dielectric slab 614.

FIG. 6B illustrates a cross section of a 1D GMR grating 610 according to another embodiment of the present invention. As illustrated in FIG. 6B, the diffraction grating 612 of the 1D GMR grating 610 comprises periodically alternating strips of a first dielectric material and a second dielectric material within the dielectric slab 614. The strips are periodically spaced apart at the grating period Λ and are essentially parallel to one another. In some embodiments, a width measured in a direction of the grating period Λ (i.e., in a direction of alternation of the strips) is essentially the same from one strip to the next. A refractive index n₁ of the first dielectric material differs from a refractive index n₂ of the second dielectric material, which results in a periodically alternating refractive index along the direction of the grating period Λ. The periodically alternating refractive indices produce the diffraction grating 612 within the dielectric slab 614.

In particular, the GMR filter may be fabricated using many conventional manufacturing methodologies including, but not limited to, microlithography/nanolithography-based surface patterning used in circuit fabrication. For example, conventional semiconductor manufacturing techniques (e.g., a CMOS compatible fabrication process) may be employed to create a GMR grating on a surface of an integrated circuit (IC). The materials chosen, the grating pattern, etc. in manufacturing the GMR filter, are based on the desired spectral response.

Among the characteristics of a GMR grating is an angular relationship between an angle of incidence of an incident wave and a response of the GMR grating. The response may be either a reflection response or a transmission response. Consider a 1D GMR grating comprising a relatively shallow or thin dielectric layer and having a grating period Λ. A planar wave-vector β as a function of a free-space wavelength λ of an incident wave for the 1D grating is given by a dispersion relation of equation (1).

$$β ( λ ) = {n}_{eff} ( λ ) \frac{2 π}{λ} \qquad ( 1 )$$

where n_{eff}(λ) is an effective refractive index of a guided mode of the grating. The effective refractive index n_{eff}(λ) is a weighted average of refractive indexes of materials in which a guided-mode propagates within the 1D GMR grating. An interaction between quasi-guided modes of planar momentum within the 1D GMR grating and an incident wave (e.g., a beam of light) of wavelength λ may be described in terms of an integer mode m by equation (2)

$${β}_{m} ( λ , θ ) = \frac{2 π n}{λ} sin ( θ ) + \frac{2 π m}{Λ} \qquad ( 2 )$$

where the incident wave is incident from a medium having a refractive index n and has an angle of incidence θ and where Λ is the period of the 1D GMR grating. The interaction produces a guided-mode resonance response of the 1D GMR grating.

The guided-mode resonance response is a function of both the wavelength λ and the angle of incidence θ. In some embodiments, the guided-mode resonance response is a reflection response while in other embodiments, the guided-mode response is a transmission response of the 1D GMR grating. Herein, the angle of incidence bis defined as an angle between a principal incident direction of the incident wave and a plane parallel with a surface of the GMR grating.

The guided-mode resonance response may be detected as spectral features (e.g., peaks in the spectrum) within a spectrum of either the reflection response or the transmission response (e.g., optical reflection/transmission spectra). In particular, the spectral features for a particular integer mode m are located at wavelengths λₘ within the reflection/transmission spectra that satisfy a relation β_{ef}f(λ=|βₘ(λ, θ)|, given by equation (3).

$${λ}_{m}^{\pm } = \frac{Λ}{m} [ {n}_{eff} \pm n sin ( θ ) ] \qquad ( 3 )$$

From equation (3) it is clear that the spectral features for an m-th mode occur in pairs that are separated by a spectral distance Δλₘ that is a function of incident angle θ given by equation (4).

$${Δλ}_{m} ( θ ) = 2 n \frac{Λ}{m} sin ( θ ) \qquad ( 4 )$$

From equation (4) it is clear that for a normal angle of incidence (i.e., θ=90 degrees) the spectral distance equals zero indicating that there is just one guided-mode resonance. Moreover, it is clear from equation (4) that the spectral distance Δλₘ is independent of an absolute spectral position of the resonance as well as an intensity or amplitude of the incident wave. In fact, for a given grating period Λ, a resonance splitting occurs that results in the spectral distance Δλₘ between spectral features that is only a function of the angle of incidence θ, the refractive index of the incidence medium n, and a mode order m.

As previously stated, the choice of materials used (different values of n), grating pattern, etc used for the GMR filter are based on the desired spectral response. Although, the relationship is defined more precisely in the previous equations, a simple design rule is that the resonance wavelength is the product of the grating pitch and the effective index of the trapped mode. For visual conferencing applications in the visible light range, a good material choice would be a silicon nitride grating (n˜2) and an oxide substrate (n˜1.46). The effective index of the trapped mode is typically around 1.8 for this configuration and the required grating pitches are in the 200 to 450 nm range, a range which is well within the range capable of mass production by optical lithography. Compared to a dielectric multi-layer filter, the GMR filter fabrication for the embodiment shown in FIG. 6A which requires only a single dielectric deposition step (plus optical lithography and etching), is less costly.

For the wavelength division implementation shown in FIG. 5, the filters A and B separate light into three different (blue, green, red) wavelength components where filter A passes one set of (blue, green, red) wavelengths, and filter B passes another set of (blue, green, red) components. In one embodiment, the filters A and B could be implemented using a set of three GMR filters, each filter tuned to reject a wavelength of interest. In an alternative embodiment, the wavelength divisions filters A and B could be implemented with a single GMR filter having a triple notch, where each notch of the filter tuned to reject the wavelength of interest.

In one embodiment of the visual collaboration system described, we use laser projectors with narrow band emissions so that the required filter for the camera to reject the projector light would be composed of narrow notches at laser frequencies. In one embodiment, this system is implemented with a set of three GMR filters, each tuned to reject a wavelength of interest. In another embodiment, a single GMR filter with a triple notch could be used. Compared to the filters A and B used to implement the system shown in FIG. 5, a laser projector implementation would have narrower band characteristics. The transmission/reflection of the light can be changed by changing the pattern of the grating to make the desired transmission profile. For example, to provide a broader band (compared to a narrower band) implementation, you could increase the grating strength, use deeper holes and possibly use a material having a higher refractive index materials (such as titanium oxide.)

One of the advantages of a GMR filter compared to a multi-layer filter is improved angular tolerance. One problem with dielectric multi-layer filters is that is more difficult to provide a narrow spectral notch. When light goes thru a filter at certain angle, it has a certain notch characteristic. However, if the light is not incident to the filter at 90 degrees but instead is incident at 75 degrees—then the spectral notch moves. This means for system implementation, you either have to take into account the different angles that light may be striking the filter or you cannot provide as narrow a notch as desired. You might have to make your notch wider to capture incident angle variances. GMR filters provide for more angular tolerance. Thus, you can make a narrower notch filter so that angle dependence is less critical.

FIG. 7 shows a visual-collaborative system 600 configured in accordance with embodiments of the present invention. The system 600 is nearly identical to the system 400 except filter B and the projector 406 are replaced with a single projector 602 configured to project color images using wavelength ranges that are blocked by filter A. For example, the projector 602 can be a conventional projector using three microdisplays and color splitting optics that send red, green and blue light from the projector bulb to the corresponding display. The microdisplays can be well-known liquid crystal display (“LCD”), liquid crystal on silicon (“LCoS”), or digital-micro mirror device (“DMD”) technologies. In such a system, the functionality of filter B can be incorporated into the color splitting optics within the projector 602. Filter A is configured to transmit wavelength ranges other than the wavelengths reflected by the color splitter, as described above with reference to FIG. 5. For example, the internal color splitter can be a series of dichroic mirrors that each reflects one of the primary colors to a separate microdisplay, while passing other wavelengths of light. Each reflected color is modulated by the corresponding microdisplay, and the colors are recombined to produce images that are projected onto the first surface 410. Each microdisplay provides pixelized control of the intensity of one color. The colors not reflected by the color splitter are discarded. For example, in order to produce a red object, the microdisplays corresponding to projecting green and blue light are operated to block green and blue light from passing through the projector 602 lens.

In other embodiments, the lamp producing white light and the internal color splitter of the projector 602 can be replaced by separate lasers, each laser generating a narrow wavelength range of light that when combined with appropriate intensities produce a full range of colors. For example, the lamp and internal color splitter can be replaced by three lasers, each laser generating one of the three primary colors, red, green, and blue. Each color produced by a different laser passes through a corresponding LCD or is reflected off of a corresponding LCoS and the colors are recombined within the projector 602 to project full color images onto the first surface 410. Note that the use of a relatively narrow set of wavelengths at the projector allows the complementary set of wavelengths passed by filter A to be relatively broader, allowing more light into the captured image.

In other embodiments the function of filter A could be incorporated into the camera optics. For example the color filter mosaic that forms part of a camera's image sensor could be selected to pass only selected wavelengths.

8A shows a visual-collaborative system 700 configured in accordance with embodiments of the present invention. The system 700 is nearly identical to the system 400 except filter B and the projector 406 are replaced with a sequential color projector 702. An example of such a projector is a “DMD projector” that includes a single digital micromirror device and a color wheel filter B comprising red, green, and blue segments. The color wheel filter B spins between a lamp and the DMD, sequentially adding red, green, and blue light to the image displayed by the projector 702. Also, filter A is replaced by a second color wheel filter A which contains filters that transmit complementary colors to those of filter B. For example, as shown in FIG. 8B, the color wheel filter A can use cyan, yellow, and magenta transparent color panels to sequentially block the color being projected through the color wheel filter A. Color wheel filters A and B can be synchronized so that when the color wheel filter A transmits one color the color wheel filter B transmits a complementary color. For example, when the red panel of the color wheel filter B passes between the lamp and the DMD of the projector 702, the color red is projected onto the screen 402 while the cyan panel of the color wheel filter A covers the lens 408 enabling the camera 404 to capture only green and blue light and ignore the projected red light.

FIG. 8C shows exemplary plots 704-706 of wavelength ranges over which color wheel filters A and B, respectively, can be operated to transmit light in accordance with embodiments of the present invention. Plot 704 shows that at a first time T₁, filter B passes a different range of wavelengths than filter A. Plot 705 shows that at a later second time T₂, filter B passes a range of wavelengths sandwiched between two different wavelength ranges passed by filter A. Plot 706 shows that at a later time T₃, filter B again passes a different range of wavelengths than filter A. In other words, plots 704-706 reveal that at any given time, filters A and B are operated to pass different wavelength ranges. Plots 704-706 also reveal that filters A and B can be operated to pass wavelengths over the same wavelength ranges, but not at the same time.

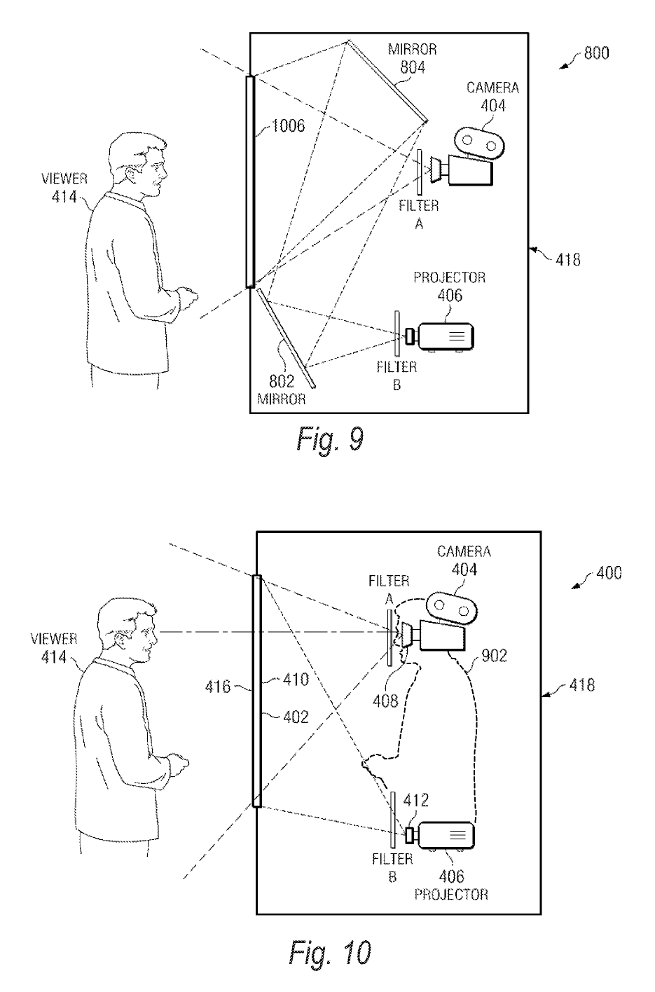

In still other embodiments, the housing 418 can include fully reflective mirrors that reflect projected images onto a display screen within the range of angles for which the screen is diffusive. FIG. 9 shows a visual-collaborative system 800 configured in accordance with embodiments of the present invention. The system 800 is nearly identical to the system 400 except mirrors 802 and 804 are included to reflect images produced by the projector 406 onto a display screen 806 within a range of angle for which the screen 806 is diffusive.

The visual-collaborative systems described above with reference to FIGS. 4-9 can be used in interactive video conferencing. The camera 404 and projector 406 can be positioned so that the display screen 402 acts as a window to a remote site. This can be accomplished by positioning the camera 404 at approximately eye level to the viewer 414 facing the second surface 416 and at approximately the same distance the viewer 414 would feel comfortable standing away from the screen. FIG. 10 shows the camera 404 positioned at approximately eye level to the viewer 414 in accordance with embodiments of the present invention. As a result, the viewer 414 appears face-to-face with a second viewer represented by dashed-line FIG. 902 located at a remote site. The second viewer 902 and the viewer 414 can engage in an interactive, virtual, face-to-face conversation with the display screen 402 serving as a window through which the second viewer and the viewer 414 can clearly see each other.

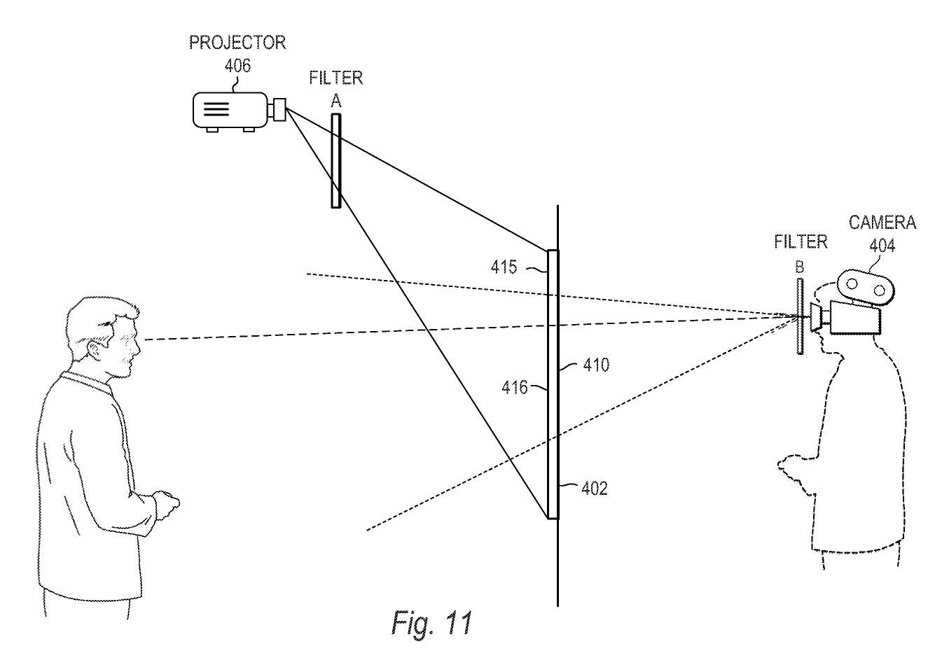

FIG. 11 shows a schematic representation of a seventh visual-collaborative system configured in accordance with embodiments of the present invention. As previously stated, FIGS. 4-5 and 7-10 are shown implemented using a rear-projection configuration. The visual-collaboration systems shown in FIGS. 11-14 are implemented using a front-projection implementation. The systems are similar in that in both rear and front projection systems project images onto a projection surface where the projected image is visible on the second surface of the display screen. However, the position of the camera and possibly the materials used for the display screen or the display screen configuration may be different.

Similar to the implementation shown in FIG. 4, the embodiment shown in FIG. 11 includes a display screen 402, a camera lens 404, and a projector 406. However, instead of being positioned behind or in the rear of the screen (relative to the viewer 414), the projector 406 in FIG. 11 is positioned in front of the display screen. The projector 406 projects an image onto a projecting surface 415. In this case, the projection surface 415 is the second surface of the display screen 102. The projected image is diffusely reflected off the second surface and can be observed by viewing the second surface.

In FIG. 11 the display screen 402 is a front-projection display screen. In one embodiment, the display screen 402 is comprised of a partially diffusing material that diffuses light striking it within a first and second range of angles. A viewer 414 facing the outer second surface 416 of the screen 402 sees the images projected onto the screen 402 from the projector 406. Similar to the embodiments described in FIGS. 4-5 and 7-10, the screen is configured to transmit light scattered from objects facing the second surface 416. In other words, the lens of the camera is positioned to face the first surface 410 so that light from objects facing the second surface 416 pass through the display screen and is captured by the camera 404.

In one embodiment, the display screen is comprised of a material that has a relatively low concentration of diffusing particles embedded within a transparent screen medium. The low concentration of diffusing particles allows a camera 404 to capture an image through the screen (providing the subject is well lit), while it diffuses enough of the light from the projector 406 to form an image on the screen. In an alternative embodiment, the display screen 402 is comprised of a holographic film that has been configured to accept light from the projector 406 within a first range of angles and reflect light that is visible to the viewer 414 within a different range of viewing angles. In some cases, the screen's partially diffusing material may not have sufficient reflective properties to reflect the projected image from the second surface of the display screen. In this case, the display screen includes a half silvered material (not shown) may be positioned directly behind and preferably in contact with the first surface of the display screen. The half silvered mirror will allow transmission of light through the display screen while enhancing the reflectivity of the holographic film.

In the front projection screen embodiment, the light projected onto the second surface within the first range of angles is diffused by the screen and can be observed by viewing the second surface 416 and light scattered off of objects facing the second surface are transmitted through the display screen to the camera. In the front projection embodiment, light from the projector that is transmitted through the display screen can degrade the performance of the system. In order to minimize this degradation, a filter A disposed between the camera and the first surface of the display screen is used to block the light received by the camera that is produced by the projector. In addition, in the preferred embodiment a filter B disposed between the projectors light source and the projection surface (in this case the second surface) where the second filter passes light output by the projector that is blocked by the first filter.

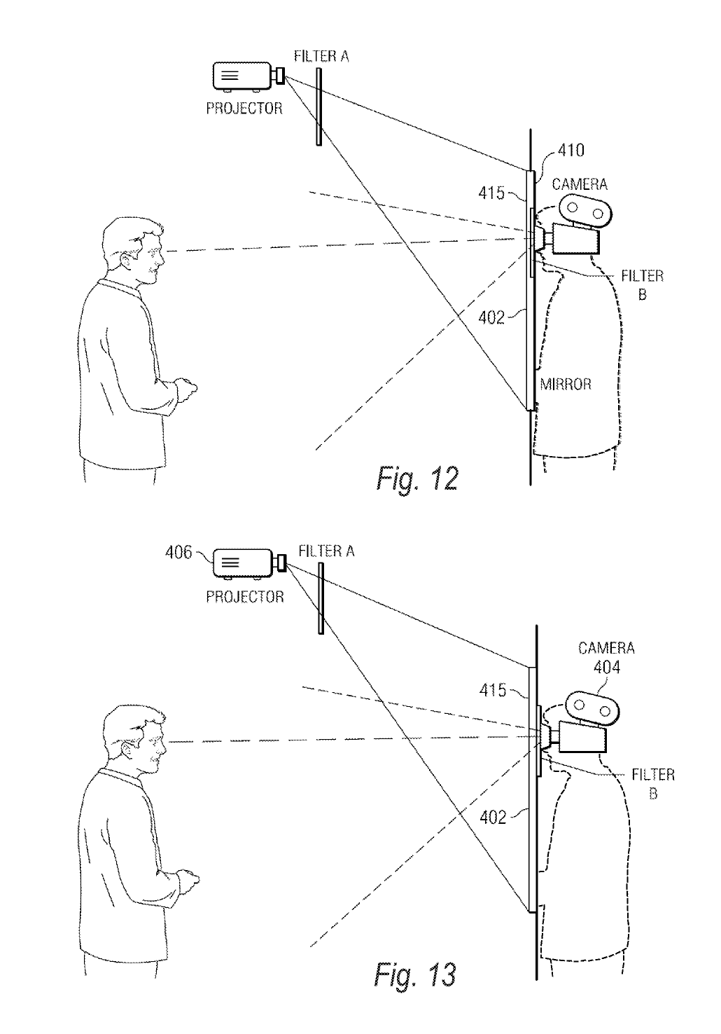

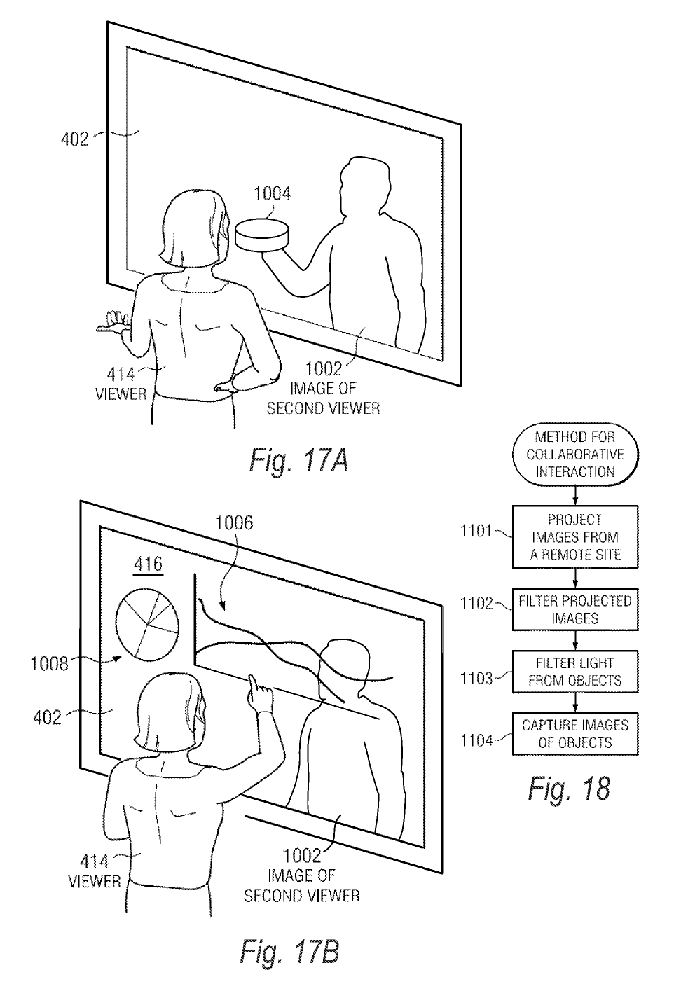

Referring to FIG. 12 shows a schematic representation of an eight visual-collaborative system configured in accordance with embodiments of the present invention. The implementation of the embodiment shown in FIG. 12, is similar to that of FIG. 11, except for the camera placement and the addition of a mirror 480. The mirror 480 is a completely reflective mirror with an opening 482 for the placement of the filter B. Although the completely reflective mirror improves the projection image, light cannot pass through it. Thus, the camera's position changes. In one embodiment, the camera is positioned so that it is in physical contact with the display system filter B. Since the camera is not a distance away from the display screen, any writings on the display screen such as is shown in FIG. 17, are not easily viewable.

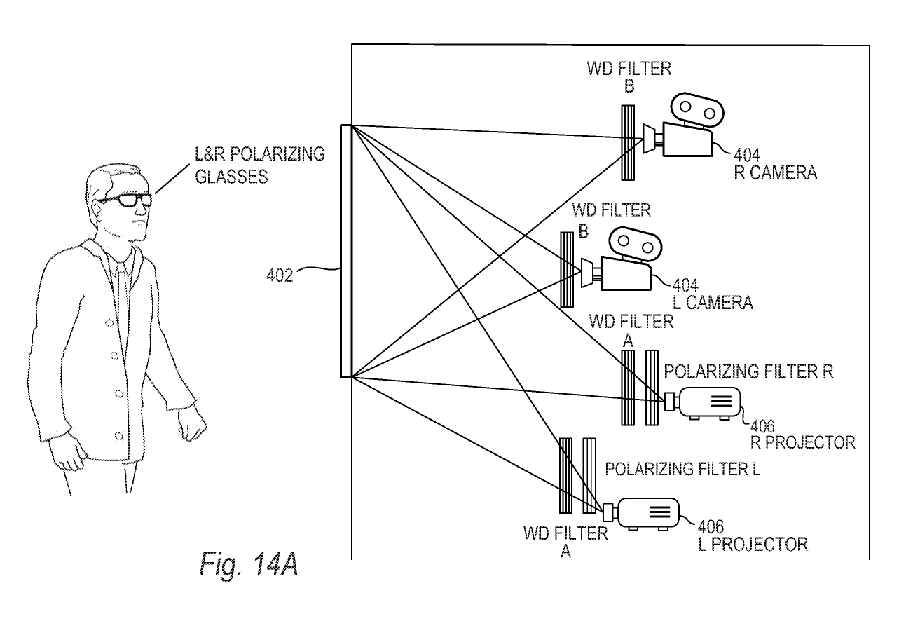

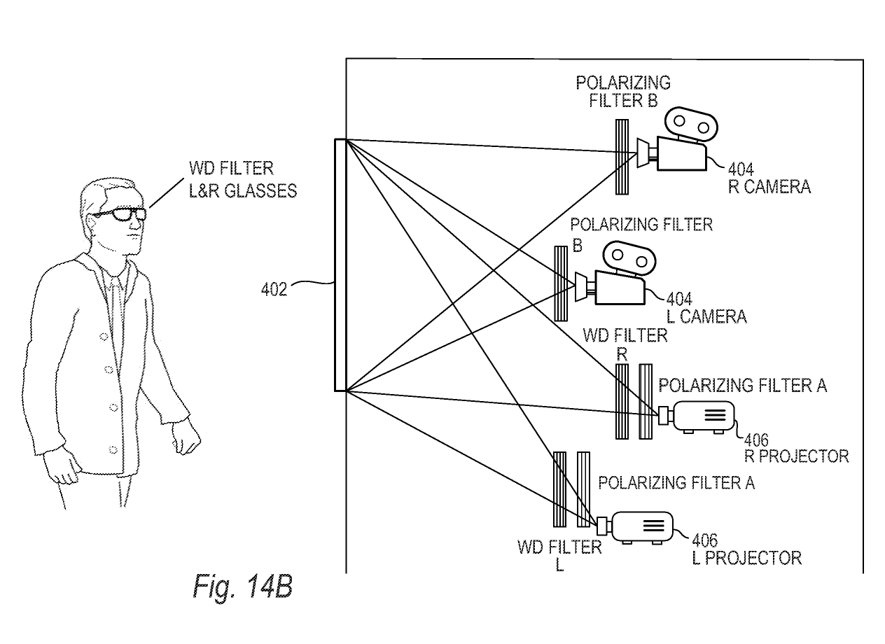

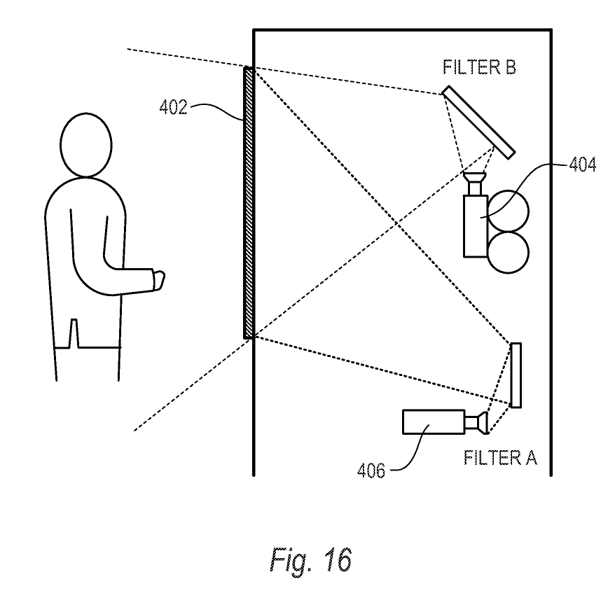

Referring to FIG. 13 shows a schematic representation of a ninth visual-collaborative system in accordance with embodiments of the present invention. The implementation of the embodiment shown in FIG. 13 is similar to that shown in FIG. 11. However, instead of the display screen being comprised of a partially diffusing material, the display screen is comprised of standard front-projection screen material. The replacement of the display screen with standard projection screen material decreases costs. However, because the standard projection screen material does not transmit light, the implementation of a collaborative board as shown in FIGS. 16A and 16B is not feasible using this configuration. In the embodiment shown in FIG. 14A-14B, the display screen includes an opening. Similar to the embodiment shown in FIG. 13, a filter A is positioned so that the filter covers the opening. A camera is positioned so that it's lens abuts the filters so that light received by the camera is filtered by filter A.

Referring to FIGS. 14A-14B shows a schematic representation of a tenth representation of an embodiment of the present invention. The representation in FIGS. 14A-14B shows a rear projection screen implementation which is capable of projecting and capturing stereoscopic 3D images. Although the embodiments shown in FIGS. 14A-14B show a rear projection screen implementation, alternatively the embodiments could be used in a front projection screen implementation. In both the rear projection screen and front projection screen implementations, instead of a single projector, two projectors, a right projector and a left projector are used, Although FIGS. 14A and 14B show two cameras, a right camera and a left camera, alternatively a single camera may be used. In the case where two cameras and two projectors are used, the remote user and the projected image will both appear in 3D. In the embodiment where a single camera is used, the remote user will no longer appear in 3D, however, the projected image will still appear in 3D.

Similar to the embodiments described with respect to FIGS. 4-5 and 7-12, light produced from each projector is blocked by the filters that pass light received by each camera. For the 3D implementation to work, the screen material for the embodiments shown in FIGS. 14A-B needs to be polarizing-preserving material. In the embodiment shown in FIG. 14A, each camera has an identical wavelength division filter. In the embodiment shown, for the projector, two different filters (a polarizing filter and a wavelength division filter) are used for each projector. For simplification purposes, the projectors used in the described implementation are the type which result in no polarization of the light output from the projectors.

In the embodiment shown in FIG. 14A, the two wavelength division filters A are identical. The two polarizing filters are of the same type. For example, in one embodiment, the two polarizing filters are circularly polarized filters where one filters is a right circularly polarized filter and the other filter is left circularly polarized filter. In another embodiment, the polarized filters are linearly polarized where the two polarizing filters are preferably orthogonal to each other. For example in one embodiment, for the left projector, a 45 degree polarizing filter is used for the polarizing filter L and a wavelength division color filter is used for WD filter A. For the right projector, a −45 degree polarizing filter is used for polarizing filter R and a wavelength division color filter is used for WD filter A. The two wavelength division color filters used for the Right Projector and the Left Projector should be identical. In the embodiment shown in FIG. 14A, the 3D image can be seen using L&R polarizing glasses.

In the embodiment shown in FIG. 14B, instead of the filters for the cameras being identical wavelength division filters, they are identical polarizing filters B. In the embodiment shown in FIG. 14B, again each projector has two corresponding different filters (a polarizing filter and a wavelength division filter). Again for simplification purposes, the projectors used in the described implementation are the type which result in no polarization of the light output from the projectors.

In the embodiment shown in FIG. 14B, the two filters used in conjunction with the projectors are wavelength division filters that block different components of light. The polarizing filters used in conjunction with the projectors are of the same type. In the embodiment shown in FIG. 14B, the 3D image can be seen using wavelength division L&R glasses.

Although in the embodiment shown in FIGS. 14A and 14B, two different filters (a polarizing filter and a wavelength division filter) are used, in one embodiment a single filter is used. Additionally, because of the properties of GMR filters, in one embodiment the polarizing features and wavelength division features of the filter are combined so that a single GMR filter having both properties is used. Thus referring to the embodiment shown in FIG. 14A, for example, the polarizing filter R and wavelength division filter A can be replaced with a single GMR filter that has both wavelength division and polarizing features.

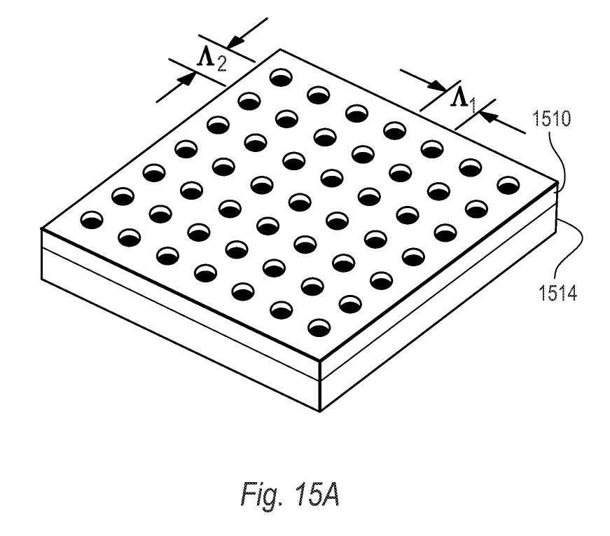

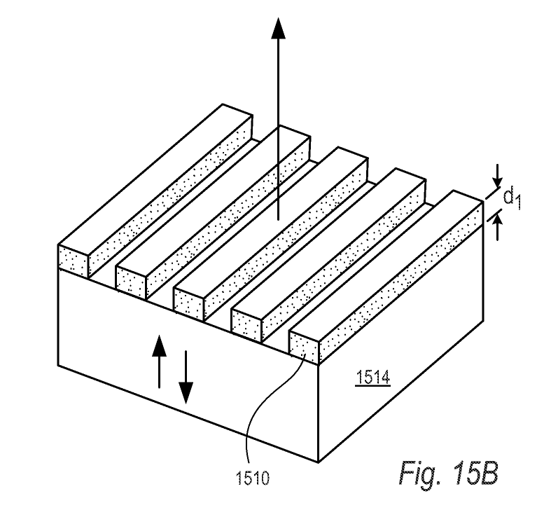

FIG. 15A illustrates a perspective view of a 2D diffraction grating (referred to herein as GMR grating 1510) according to an embodiment of the present invention. The GMR filter can be polarizing or non-polarizing depending on the nature of the grating pattern (1D or 2D). The rejected wavelength is controlled by the periodicity of the grating.

The embodiment shown in FIG. 15A illustrates a non-polarizing 2D GRM. As illustrated, diffraction grating 1510 of the 2D GMR grating comprises a 2D periodic array of holes formed in a surface layer of the dielectric slab 1414. The 2D periodic array of holes has a 2-dimensional period A that introduces a periodically repeating refractive index discontinuity in the surface layer of the dielectric slab 1514. The periodically repeating refractive index discontinuity produces the diffraction grating 1512.

For example, the dielectric slab 1514 may comprises a silicon on insulator (SOI) wafer and the diffraction grating 1510 may comprise a square lattice of holes etched in a surface of the silicon (Si). In this example, the holes may have a diameter of about 400 nanometers (nm) and be etched to a depth of about 25 nm. A spacing between, or period Λ of, the holes in the square lattice may be about 1.05 micron (□m) (i.e., where Λ=Λ₁=Λ₂). In this example, the Si may be a layer having a thickness of about 50 nm.

While illustrated in FIG. 15A as holes, the 2D diffraction grating 1510 may be produced by essentially any means for introducing a 2D periodically repeating discontinuity. For example, the holes described above may be filled with a dielectric material of a different refractive index than that of the dielectric slab 1514. In another example, the 2D diffraction grating is provided by holes or filled holes (e.g., dielectric plugs) that extend completely through an entire thickness of the dielectric slab 1514. In yet another example, an array of protruding surface features (e.g., bumps) may be employed as the 2D diffraction grating. In some embodiments, a grating period Λ₁ of the 2D diffraction grating 1510 may be different in a first direction (e.g., x-axis) of the periodic array from a grating period Λ₂ in a second direction (e.g., y-axis) of the periodic array.

Referring to FIG. 15B illustrates a perspective view of a polarizing 2D GMR grating according to an embodiment of the present invention. Unlike the embodiment shown in FIG. 15A which is insensitive to polarization, the embodiment shown in FIG. 15B is sensitive to polarization. The grating in FIG. 15B is a series of parallel grooves. In the embodiment shown in FIG. 15B, whether the light is transmitted depends upon the polarization of the incident light.

FIG. 16 shows a schematic representation of an eleventh visual collaboration system. In one embodiment, the display screen 402 is a holographic diffusing material and filters A and B are reflective GMR filters. As previsously discussed, GMR filters can be either transmissive or reflective of a desired wavelength. In the embodiment shown in FIG. 16, both filters A and B are reflective filters. The reflective properties of the GMR filters A and B allow for alternative positioning of the camera and projector compared to the embodiments shown in FIGS. 4 and 7-14. This alternative positioning or configuration allows the camera and projector to be positioned closer to the screen than in the previous embodiments so that the system and housing for the visual-collaborative system have a smaller footprint.

FIG. 17A shows an isometric view of an interactive video conference between the viewer 414 and a projected image of a second viewer 1002 located at a remote site in accordance with embodiments of the present invention. The second viewer 902 is projected on the display screen 402 by the projector (not shown), as described above with reference to FIGS. 4-16. As shown in FIG. 17A, a visual-collaborative system configured in accordance with embodiments of the present invention enables the second viewer 1002 to visually display and present an object 1004 for the viewer 414 from the remote site.

In other embodiments, the second surface 416 of the display screen 402 can be configured or coated with a transparent and erasable material enabling the viewer 414 to write and erase on the second surface 416 during an interactive video conference. In other embodiments a transparent, electronic, interactive surface (e.g., a touch screen) may be disposed on the second surface 416 of display screen 402, enabling the viewer 414 to draw, or otherwise interact with computer generated imagery overlaid on the video image of the remote user 1002 projected on the screen. In still other embodiments, other optical or ultrasound based tracking techniques may be used to track the viewer's 414 gestures or a pointer in order to interact with the computer generated imagery. In all these embodiments, the video images of the viewers 414 and 1002 are relayed between the local and remote sites and are mirrored horizontally so that the remote viewer 1002's writing appears correctly oriented for the viewer 414. FIG. 17B shows an isometric view of a video conference between the viewer 414 and the second viewer 1002 with the second surface 416 configured as a transparent writing surface in accordance with embodiments of the present invention. As shown in FIG. 17B, the viewer 414 has drawn a graph 1006 on the second surface 416. The camera 404 (not shown) located behind the screen 402 captures an image of the viewer 402 and the graph 1006, which can be observed by the second viewer 1002. The display screen 402 also exhibits a pie chart 1008 drawn by the second viewer 702 on a similar transparent writing surface at the remote site. The projector 406 (not shown) displays the second viewer 1002 and the chart 1008 for observation by the viewer 414.

FIG. 18 shows a flow diagram for a method for video collaborative interaction method in accordance with embodiments of the present invention. Steps 1101-1104 do not have to be completed in any particular order and can be performed at the same time. In step 1101, images captured at a remote site are projected on a rear or front projection display screen, as described above with reference to FIGS. 4-13. In step 1102, the projected images are filtered, as described above with reference to FIGS. 4-5-17. In step 1103, light is filtered. For the embodiment where the filters are wavelength division filters, the wavelengths of light reflected and emitted from objects pass through the display screen and are filtered so that the wavelengths of light used to project images on the display screen are different from the wavelengths of light passing through the screen, as described above with reference to FIG. 5. In step 1104, the wavelengths of light passing through the screen are captured, as described above with reference to FIGS. 4-8.

Embodiments of the present invention have been demonstrated using a dnp Holo Screen™ from DNP, a Canon Vixia HF 100 HD camcorder, and a Mitsubishi HC600HD projector. Images were projected onto the holographic screen at an angle of approximately 35° from a distance of approximately 8 ft. The optical path length was folded using a visual-collaborative system similar to the system 800, described above with reference to FIG. 9. The camera was positioned to a have a view of the back of the holographic screen from an average eye height and a distance of approximately 2 ft, which is roughly the distance a viewer stands from the screen.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A visual-collaborative system comprising:
a display screen having a first surface and a second surface;
a first projector positioned to project images onto a projection surface of the display screen, wherein the projected images can be observed by viewing the second surface; and
a first camera system positioned to capture images of objects through the display screen, the first camera system including a first filter disposed between a first camera and the first surface, wherein the first filter passes the light received by the camera but substantially blocks the light produced by the first projector, wherein the first filter is a GMR (Guided Mode Resonance) filter.

2. The system of claim 1 wherein the visual-collaborative system further comprises:
a second filter in the optical path between the light source of the first projector and the projection surface of the display screen, wherein the second filter passes the light output by the first projector that is substantially blocked by the first filter, wherein the second filter is a GMR filter.

3. The system of claim 1 wherein the first filter is configured to substantially block a first set of wavelength ranges and substantially transmit a second set of wavelength ranges.

4. The system of claim 2 wherein the second filter is configured to substantially block the second set of wavelength ranges and substantially transmit the first set of wavelength ranges.

5. The system of claim 2 wherein the display screen is polarization-preserving screen and the first and second filters are polarizing filters.

6. The system of claim 1 wherein the display screen is a rear projection screen and the projection surface of the display screen is the first surface.

7. The system of claim 2 wherein the display screen is a rear projection display screen and the projection surface of the display screen is the first surface.

8. The system of claim 1 further comprising an interactive surface disposed on the second surface enabling a viewer to interact with the images projected onto the second surface.

9. The system of claim 2 further comprising an interactive surface disposed on the second surface enabling a viewer to write on the second surface.

10. The system of claim 1 wherein the display screen is a front projection screen and the projection surface is the second surface.

11. The system of claim 2 wherein the display screen is a front projection screen and the projection surface is the second surface.

12. The system of claim 11 wherein the display screen further includes a half silvered mirror physically located behind a first surface of the partially diffusing display screen.

13. The system of claim 11 wherein the first camera system is positioned so that it is in physical contact with the display screen.

14. The system of claim 2 wherein the display screen is a polarization preserving screen, wherein the first projector is associated with a single GMR filter that includes a filter of the first type and a filter of the second type, and further including a second projector associated with a single GMR filter that includes a filter of the first type and a filter of the second type.

15. The system of claim 2 wherein the display screen is a polarization preserving screen, wherein the first projector is associated with two filters, a filter of the first type and a filter of the second type, and further including a second projector associated with two filters, a filter of the first type and a filter of the second type.

16. The system of claim 14 wherein the first camera system is associated with a filter of the first type and 3D images may be seen by a viewer wearing glasses having filters of the second type.

17. The system of claim 14 wherein the first camera system is associated with a filter of the second type and 3D images may be seen by a viewer wearing glasses having filters of the first type.

18. The system of claim 15 further including a second camera system positioned to capture images of objects through the display screen, the second camera system including a first filter of a first type disposed between the second camera and the second surface of the display screen, wherein the first filter of the second camera system passes the light received by the second camera but substantially blocks the light produced by the first and second projectors, and further wherein the first filter of the first camera system passes the light received by the first camera but substantially blocks the light produced by the first and second projectors.

19. The system of claim 18 wherein the filters associated with the first and second camera systems are of a first type and the 3D images may be seen by a viewer wearing glasses having a filters of the second type.

20. A method comprising:
projecting images onto a projection surface of the display screen; and
simultaneously capturing images of objects through the display screen with a camera system, the camera system including a first filter disposed between a camera and the first surface of the display screen, wherein the first filter passes light received by the camera but substantially blocks the light produced by the projector, wherein the first filter is a GMR filter.

21. The method of claim 20 further including the step of filtering light of the projected image through a second filter disposed in the optical path between the light source of a projector and a projection surface of the display screen, wherein the second filter passes the light output by the projector that is substantially blocked by the first filter, wherein the second filter is a GMR filter.
